(19) United States
(12) Patent Application Publication
(10) Pub. No.: US 2014/0363654 A1
(43) Pub. Date: Dec. 11, 2014

(54) FLAME-RETARDANT POLYAMIDE MOULDING COMPOSITIONS

(71) Applicant: EMS-PATENT AG, Domat/Ems (CH)

(72) Inventors: Mark D. ROTH, Erndtebruck (DE); Nikolai LAMBERTS, Bonaduz (CH); Pierre DUBON, Zurich (CH); Gion Antoni TUOR, Rhazuns (CH)

(73) Assignee: EMS-PATENT AG, Domat/Ems (CH)

(21) Appl. No.: 14/297,852

(22) Filed: Jun. 6, 2014

(30) Foreign Application Priority Data
Jun. 6, 2013 (EP) 13 170 801.8

(51) Int. Cl. C08K 7/14; C08K 5/5313

(52) U.S. Cl. CPC C08K 7/14; C08K 5/5313
USPC 428/220; 524/133

(57) ABSTRACT

The present invention relates to a flame-retardant polyamide moulding composition with good mechanical properties with the following constitution:
(A) from 25 to 90% by weight of at least one polyamide,
(B) from 5 to 60% by weight of glass fibres, where the arithmetic average of the length of these in the polyamide moulding composition is from 100 to 220 μm,
(C) from 5 to 25% by weight of at least one phosphinic salt and/or one diphosphinic salt,
(D) from 0 to 20% by weight of at least one additive,
   where the entirety of components (A) to (D) gives 100% by weight. The invention also relates to processes for the production of moulding compositions of this type, to mouldings produced therefrom, and also to uses.

### TECHNICAL FIELD

The present invention relates to flame-retardant polyamide moulding compositions, and also to processes for producing these and use thereof.

### PRIOR ART

Plastics in some applications are subject to stringent requirements relating to their flame-retardant properties. Provision of flame retardancy to plastics is particularly essential for use in electronic equipment, because of the risk of short circuits.

Plastics used are not only those that are per se flame-retardant (=inherent flame retardancy) and plastics coated with a flame retardant, but also plastics with a reactive flame retardant, where the flame retardant is a constituent of the plastic and has been bonded chemically thereto during polymerization. Another variant for providing flame retardancy to plastics is the incorporation of flame-retardant additives by compounding. Examples of additives commonly used are nitrogen-based compounds such as melamine and urea, brominated polystyrenes and organophosphorus compounds. Another essential requirement placed upon plastics is that they have good mechanical properties; these can be obtained inter alia through glass fibre reinforcement. Within the prior art of the polyamides sector there are some examples of glass-fibre-reinforced moulding compositions provided with flame retardancy. Achievement of fire protection class UL 94 V-0 represents a particular challenge for glass-fibre-reinforced polyamide moulding compositions. The prior art describes a number of glass-fibre-reinforced polyamide moulding compositions provided with flame retardancy.

It is moreover important that the polyamides have good processability, e.g. in injection-moulding machines, and without any occurrence of corrosion problems or the like.

EP 2 100 919 A1 relates to flame-retardant polyamide resin compositions comprising a polyamide resin, a phosphorus-containing flame retardant and glass fibres with non-circular cross section. According to the teaching of the said, specification, better flame-retardant properties are obtained by using glass fibres with non-circular cross section, known as flat glass fibres, than by using glass fibres with circular cross section.

WO 00/73375 A2 moreover discloses polyamide resin compositions provided with flame retardancy which on the one hand comprise either an organic phosphorus compound, melamine, or a melamine-derived compound or a melamine-phosphorus compound. On the other hand, the compositions comprise a specific polymer compound in which olefinic constituents and epoxy groups, acid groups or anhydride groups are present.

DE 36 09 341 A1 describes reinforced polyamide moulding compositions provided with flame retardancy in which melamine or melamine cyanurate and unsized glass fibres are present.

### DESCRIPTION OF THE INVENTION

An object of the present invention inter alia is to provide polyamide moulding compositions provided with flame retardancy and having very good mechanical properties. This object is achieved via a moulding composition of the following constitution:
(A) from 25 to 90% by weight of at least one polyamide,
(B) from 5 to 60% by weight of glass fibres, where the average of the length of these in the polyamide moulding composition is from 100 to 220 μm,
(C) from 5 to 25% by weight of at least one phosphinic salt and/or one diphosphinic salt,
(D) from 0 to 20% by weight of at least one additive and/or additional substance,
   where the entirety of components (A) to (D) gives 100% by weight.

Surprisingly, the moulding compositions of the invention feature improved flame-retardant properties in comparison with moulding compositions with glass fibres of average length above 220 μm. Because the classification V-0 in accordance with UL 94 is achieved, mouldings made of the moulding compositions of the invention can be used for specific applications in the electrical and electronics industry.

In comparison with moulding compositions having greater glass fibre lengths, the shrinkage of the moulding compositions of the invention during processing is more isotropic, and the moulding compositions of the invention are therefore less susceptible to warpage, and it is therefore possible to produce large-surface-area components such as rear walls of housings of switchgear cabinets and the like, or components of complicated design with sophisticated geometry, where replication of the shape of these is adversely affected by highly anisotropic shrinkage.

For the purposes of the present invention, the expression “average length” used for glass fibres means the average length (arithmetic average) determined in accordance with a section of ISO 22314:2006(E) with the tolerances mentioned in the description in respect of the standard. The arithmetic average length of the glass fibres in the moulding composition is therefore determined in accordance with the procedure stated in the detailed description by starting from a sample of the polyamide moulding composition. The value here is the average length of the glass fibres present in the polyamide moulding composition, and not necessarily the average length of the glass fibre starting material. It is namely one of the essential other aspects of the present invention that a moulding composition of this type can also be produced by starting from glass fibres that are originally longer; the processing method, in particular the extrusion process, being adjusted in such a way that the average fibre length in the resultant polyamide moulding composition and, respectively, in a polyamide moulding produced therefrom is then in the claimed range from 100 to 220 μm.

The fibre length here is in essence determined in accordance with the international standard ISO 22314:2006. However, because when flame retardants are present the ashing prescribed in that standard (cf. 6.1: ashing in accordance with ISO 1172 for 1.5 hours) does not always separate glass fibres from the remainder of the material so that they can be measured effectively with a microscope in accordance with 6.3 of the standard, it was necessary to select a somewhat modified procedure: in the present method a suitable solvent is used to dissolve the constituents other than the glass fibres, namely components (A), (C) and (D) out from the polyamide moulding composition defined above. The determination of the average length of the glass fibres present in the polyamide moulding composition therefore takes place in accordance with ISO 22314:2006 with the exception that a suitable solvent is used instead of the ashing prescribed in that standard to separate the glass fibres from the remainder of the material (cf. detailed description in the Examples).

The moulding compositions of the invention moreover have better tensile strain at break than comparable moulding compositions in glass fibres of conventional average length.

Another advantage of the moulding compositions of the invention consists in their improved glow wire resistance.

It is preferable that the polyamide (A) is selected from the following group consisting of: PA 6; PA 46; PA 66; PA 66/6; PA 610; PA 612; PA 1010; PA 11; PA 12; PA MXD6 (MXD=meta-xylylenediamine); PA MXD10; PA MACM 12; PA PACM 12; PA 6T/6I; PA 6T/66; PA 6T/612; PA 6T/1012; PA 4T; PA 9T; PA 10T; PA 12T; PA 10/6T; PA 6T/6I/66; PA 11/10T; PA 12/10T; PA 610/10T; PA 612/10T; PA 1010/10T; PA 1012/10T; PA 1212/10T; PA 11/10T/12; PA 11/10T/6; PA 12/10T/6; PA 11/10T/10I; PA 11/10T/106; PA 12/10T/10I; PA 12/10T/106; PA MPMDT (PA MPMDT=polyamide based on a mixture of hexamethylenediamine and 2-methylpentamethylenediamine as diamine component and terephthalic acid as diacid component); polyamides having the diamine unit PACM (PACM=4,4′-diaminocyclohexylmethane), MACM (MACM=3,3′-dimethyl-4,4′-diaminocyclohexylmethane), CHDA (CHDA=cyclohexyldiamine) or TMDC (TMDC=2,2′,6,6′-tetramethyl-4,4′-methylenebis(cyclohexylamine)); and mixtures of these. Particular preference is given to aliphatic polyamides, and in particular preference is given to the polyamide (A) PA 6 or PA 66, and most preference is given to an alloy of PA 66 and PA 6.

The amount of the polyamide (A) present in the composition of the invention is from 25 to 90% by weight, preferably from 35 to 80% by weight and with particular preference from 45 to 75% by weight.

In another preferred embodiment, the composition comprises from 35 to 60% by weight of PA 66 and from 5 to 15% by weight of PA 6, where the data are always based on the entire composition, i.e. on the entirety of components (A)-(D).

The relative viscosity of the polyamides (A) used, determined in accordance with ISO 307 (0.5 g of polyamide in 100 ml of formic acid at 25° C.), is preferably from 1.80 to 2.30, preferably from 1.85 to 2.25 and particularly preferably from 2.05 to 2.20.

According to another embodiment of the polyamide moulding composition proposed, the glass fibres (B) are fibres with an average length in the range from 100 to 220 μm, preferably from 120 to 200 μm and with particular preference from 135 to 190 μm. The length of the glass fibre (B) here is the average length determined as described in the experimental section. If glass fibres of length below 100 μm are used, there is an excessive decrease in the level of mechanical properties, and glass fibres of length above 220 μm lead to impaired flame-retardant properties.

It is possible here to use glass fibres (B) which have been ground in advance in order to adjust them to the abovementioned length. It is moreover possible to adjust the length during the compounding step, by feeding commercially available staple fibres by way of the extruder intake and using the shear over the entire length of the extruder screw to shorten the fibres. It is also possible to compound the glass fibres (B) with component A in a ratio of 1:1 in an extruder. The resultant glass fibre concentrate (masterbatch) is then mixed in the extruder with the amounts of components A, C and D required to achieve the intended mixing ratio. It is preferable to feed the glass fibres by way of the extruder intake.

The average diameter of the glass fibres (B) is from 7 to 15 μm, and fibres in particular used here have circular and/or non-circular cross-sectional area, where the dimensional ratio of the major cross-sectional axis to the minor cross-sectional axis in the case of flat glass fibres is in particular >2:1, preferably in the range from 2:1 to 5:1 and particularly preferably in the range from 3:1 to 4.5:1. In one preferred embodiment, the cross section of the glass fibres used is exclusively circular.

For reinforcement of the moulding compositions of the invention it is also possible to use mixtures of glass fibres (B) with circular and non-circular cross section, where the proportion of glass fibres with circular cross section preferably predominates as defined above, i.e. makes up more than 50% by weight of the entire composition of the fibres.

The glass fibre (B) itself can, irrespective of the shape of the cross-sectional area and the length of the fibre, be selected from the group of E glass fibres, A glass fibres, C glass fibres, D glass fibres, M glass fibres, S glass fibres and/or R glass fibres, preference being given to E glass fibres, R glass fibres and S glass fibres.

It is preferable that the glass fibres (B) have been provided with a size, composed of polyurethane as film-former and aminosilane as coupling agent.

The amount of component (B) present in the composition of the invention is preferably from 5 to 55% by weight, particularly preferably from 10 to 50% by weight and in particular preferably from 15 to 40% by weight.

As component (C) it is preferable to use phosphinic salts of the general formula (I) and/or formula (II) and/or polymers thereof, where R1 and R2 can be identical or different and can be C1-C8-alkyl, linear or branched and/or aryl. R3 can be C1-C10-alkylene, linear or branched, C6-C10-arylene, -alkylarylene or -arylalkylene. M is a metal ion from the 2nd or 3rd main or transition group of the periodic table of the elements, and it is preferable here to use Al, Ba, Ca and Zn. m is preferably 2 or 3, n is preferably 1 or 3 and x is preferably 1 or 2.

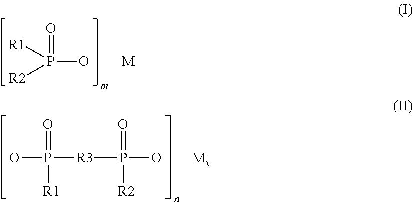

Particularly preferred as component (C) is the flame retardant Exolit OP 1230 marketed by Clariant, which is the aluminium salt of diethylphosphinic acid (CAS No. 225789-38-8).

The amount of component (C) present in the composition of the invention (proportion, based on the entire amount of components (A)-(D)) is preferably from 5 to 25% by weight, particularly preferably from 6 to 23% by weight and with particular preference from 7 to 21% by weight. If more than 25% by weight of component (C) is added, there is an excessive adverse effect on mechanical properties, and in contrast at below 5% by weight the flame-retardant properties achieved are no longer very good.

Additive or additional substance (D) used can be components selected from the group consisting of glass beads, mineral powders, UV stabilizers, heat stabilizers, lubricants and mould-release aids, impact modifiers, dyes and markers, inorganic pigments, organic pigments, IR absorbers, antistatic agents, antiblocking agents, nucleating agents, crystallization accelerators, crystallization retarders, chain-extending additives, flame retardancy synergists, conductivity additives, optical brighteners, photochromic additives, crosslinking agents, intumescence agents, foreign polymers and/or mixtures thereof.

Amounts of additives and additional substances (D) present in the composition of the invention are preferably from 0.001 to 18% by weight, particularly preferably from 0.01 to 10% by weight and with particular preference from 0.1 to 5% by weight.

In one preferred embodiment, the composition is entirely free from melamine, melamine cyanurates and other melamine derivatives.

One particularly preferred polyamide moulding composition is composed of
(A1) from 5 to 40% by weight of PA 6,
(A2) from 35 to 55% by weight of PA 66,
(B) from 15 to 40% by weight of glass fibres of average length from 135 to 200 μm,
(C) from 5 to 25% by weight of at least one phosphinic salt and/or one diphosphinic salt,
(D) from 0.01 to 5% by weight of at least one additive,
   where the entirety of components (A) to (D) gives 100% by weight.

In one preferred embodiment, the glow wire flammability index (GWFI) of the polyamide moulding compositions, determined as described in the experimental section, is at least 850° C., preferably at least 900° C. and with particular preference 960° C.

In another preferred embodiment, the tensile strain at break of the polyamide moulding compositions, determined as described in the experimental section, is more than 3.5%, preferably more than 4.0% and particularly preferably more than 5.0%.

In another preferred embodiment, the polyamide moulding compositions are classified as V-0 in accordance with UL 94 for a test specimen wall thickness of 1.6 mm, preferably of 3.2 mm.

In another preferred embodiment, the ratio of longitudinal linear shrinkage to transverse linear shrinkage during injection moulding of the polyamide moulding compositions is greater than 0.40 and particularly preferably greater than 0.50.

The present invention further provides a process for the production of polyamide moulding compositions of this type. This process can be carried out by combining the constituents (A)-(D), optionally in stages, and mixing them together, for example in an extruder, where glass fibres of average length in the range from 100 to 220 μm are then used as actual starting material. According to one preferred embodiment, however, the process is characterized in that the length of the glass fibres in the resultant polyamide moulding composition is adjusted via appropriate conduct of the mixing process: during mixing the glass fibres are broken and thus shortened. In other words, this type of preferred process is characterized in that the glass fibre length in the claimed range from 100 to 220 μm is established during compounding, in particular by way of example by bringing the as yet unshortened glass fibres into contact with the kneading elements of the extruder by means of addition of the glass fibres through the extruder intake. In contrast to the conventional addition of glass fibres through the ancillary extruder into the polymer melt with non-aggressive treatment of glass fibres by the downstream kneading, mixing and conveying elements, giving an average glass fibre length above 220 μm, addition of the glass fibres together with the polymer granules into the intake can, through suitable selection and arrangement of high-shear kneading and retarding elements, achieve an average glass fibre length below 200 μm even when longer starting material is used for the glass fibres, because the glass fibres are subjected to treatment along the entire length of the extruder screw. Effective shortening of the glass fibres is ensured within the plastifying section, which is composed of dispersive kneading elements and which concludes with a retarding element, and which provides mechanical contact of the glass fibres with the polymer granules that, in the intake section prior to plastification, have not yet melted.

The usual arrangement has the kneading elements in an extruder screw section located between the intake section and the side feed, i.e. in the extruder section in which the polymer granules are melted.

Another embodiment uses an extruder screw designed in such a way that kneading blocks and mixing elements are incorporated behind the side intake. In this case, an average length distribution of the glass fibres from 100 to 220 μm is ensured even when the glass fibres are added by way of the side intake. The kneading blocks and mixing elements should then extend over a larger section of the screw, since shortening of the glass fibres is less effective than when the arrangement has the kneading elements in the homogenizing section.

It is preferable to use co- or counterrotating twin-screw extruders.

In one particularly preferred embodiment, the unreinforced polyamide moulding composition (A), optionally already with components (C) and/or (D) admixed, is charged to an extruder, and the glass fibres added, as yet unshortened, come into contact with at least one kneading element and at least one retarding element of the extruder screw.

The invention also provides the use of glass fibres of average length from 100 to 220 μm. The procedure here can either be that fibres of this average length are already used as starting materials in the production of the polyamide moulding composition or that longer glass fibres are used and that these are then shortened to the said average length in the production process (specifically generally in the extruder) in contact with the matrix. The decisive factor here is that in the resultant moulding or in the resultant polyamide moulding composition there is an average length determined by the method described above and in the experimental section. The glass fibres are used here in combination with at least one phosphinic salt and/or one diphosphinic salt for the production of flame-retardant polyamide moulding compositions/mouldings, and these are preferably classified as V-0 in accordance with IEC 60695-11-10 (UL 94) for wall thickness 1.6 mm and 3.2 mm.

The present invention further provides mouldings which are produced with use of polyamide moulding compositions of this type.

The invention further provides uses of mouldings which are composed at least to some extent of polyamide moulding compositions of this type.

Examples of these uses in the electrical/electronics sector are parts of circuit boards, of housings, of foils, of lines, of switches, of distributors, of relays, of resistances, of capacitors, of coils, of lamps, of diodes, of LEDs, of transistors, of connectors, of controllers, of storage devices and of sensors.

Because the shrinkage of the moulding compositions of the invention is more isotropic and the compositions therefore have less susceptibility to warpage, they are moreover used for large-surface-area components, for example rear walls of housings of switchgear cabinets and the like, or components of complicated design with sophisticated geometry.

The dependent claims provide further embodiments.

### DESCRIPTION OF PREFERRED EMBODIMENTS

The Inventive Examples and Comparative Examples used the materials listed in Table 1.

TABLE 1
Materials used.

| | | | | H₂O |
|---|---|---|---|---|
| | | | Rel. | content |
| Substance | Trade name | Supplier | viscosity^{a)} | [% by wt.] |
| PA 66 | Radipol | Radici (IT) | 2.05 | 0.2 |
| | A45 | | | |
| PA 6 | Domamid 27 | Domo Capro- | 2.07 | 0.04 |
| | | leuna (DE) | | |
| Antioxidant | Irganox | BASF (DE) | — | — |
| | 1098 ED | | | |
| Ca stearate | Ligastar | Greven (DE) | — | — |
| | CA 800 | | | |
| Flame | Exolit OP | Clariant | — | — |
| retardant 1 | 1230 | (DE) | | |
| Flame | Melapur MC | BASF (DE) | — | — |
| retardant 2 | 50 | | | |
| Glass | OCV 995 | OCV (FR) | — | — |
| fibres | EC10-4.5 | | | |

^{a)}determined in accordance with ISO 307 (0.5 g of polyamide in 100 ml of formic acid at 25° C.), calculation of relative viscosity (RV) based on Section 11 of the standard: RV = t/t₀.

### Specification for Compounding:

The moulding compositions for the Inventive Examples IE1, IE2 and IE3, and also for the Comparative Examples CE1, CE2 and CE3, were produced in a ZE 40Ax33D UT twin-screw extruder from Berstorff. The quantitative proportions of the starting materials stated in Table 2 in percentage by weight (% by wt.) based on 100% by wt. of the entire moulding composition were compounded in the twin-screw extruder. For Inventive Examples IE1, IE2 and IE3 and Comparative Example CE4, the glass fibres were ground via feed into the extruder intake, and these glass fibres are termed glass fibres A in Table 2. In the case of Comparative Examples CE1, CE2 and CE3 the glass fibres were in contrast added by way of the ancillary extruder, and these glass fibres are termed glass fibres B in Table 2. The resultant granules were used for injection-moulding of test specimens on which the properties stated in Table 2 were determined.

TABLE 2
Composition and properties of the Examples:

| Composition | IE1 | IE2 | IE3 | IE4 | IE5 | CE1 | CE2 | CE3 | CE4 |
|---|---|---|---|---|---|---|---|---|---|
| PA 66 | 50.0 | 43.64 | 39.64 | 57.96 | 38.04 | 50.0 | 43.64 | 39.64 | 43.64 |
| PA 6 | 12.5 | 10.91 | 9.91 | 14.49 | 9.51 | 12.5 | 10.91 | 9.91 | 10.91 |
| Antioxidant | 0.3 | 0.25 | 0.25 | 0.35 | 0.25 | 0.3 | 0.25 | 0.25 | 0.25 |
| Ca stearate | 0.2 | 0.2 | 0.2 | 0.2 | 0.2 | 0.2 | 0.2 | 0.2 | 0.2 |
| Flame retardant 1 | 7.0 | 15.0 | 20.0 | 12.0 | 12.0 | 7.0 | 15.0 | 20.0 | — |
| Flame retardant 2 | — | — | — | — | — | — | — | — | 15 |
| Glass fibre A | 30.0 | 30.0 | 30.0 | 15 | 4.0 | — | — | — | 30.0 |
| Length distribution [μm]^{a)} | 180 | 178 | 182 | 185 | 174 | — | — | — | 187 |
| Glass fibre B | — | — | — | — | — | 30.0 | 30.0 | 30.0 | — |
| Length distribution [μm]^{a)} | — | — | — | — | — | 357 | 360 | 354 | — |
| Properties | | | | | | | | | |
| Tensile strain at break [%] | 8.2 | 6.0 | 5.0 | 8.5 | 5.1 | 3.5 | 3.3 | 3.4 | 3.0 |
| Charpy impact resistance [kJ/m²] | 64 | 50 | 46 | 54 | 56 | 71 | 56 | 49 | 30 |
| Longitudinal linear | — | 0.35 | — | 0.55 | — | — | 0.20 | — | 0.50 |
| shrinkage during | | | | | | | | | |
| injection moulding (S_{Mp}) [%] | | | | | | | | | |
| Transverse linear | — | 0.55 | — | 0.70 | — | — | 0.65 | — | 0.80 |
| shrinkage during | | | | | | | | | |
| injection moulding (S_{Mn}) [%] | | | | | | | | | |
| Shrinkage ratio S_{Mp}/S_{Mn} | | 0.64 | | 0.79 | | | 0.31 | | 0.63 |
| UL 94 (1.6 mm), 48 h sc | V-1 | V-1 | V-1 | V-0 | V-1 | n.c. | n.c. | n.c. | V-2 |
| UL 94 (1.6 mm), 7 days, 70° C. | V-2 | V-1 | V-1 | V-0 | V-1 | n.c. | n.c. | n.c. | V-2 |
| UL 94 (1.6 mm), classification | V-2 | V-1 | V-1 | V-0 | V-1 | n.c. | n.c. | n.c. | V-2 |
| UL 94 (3.2 mm), 48 h sc | V-0 | V-0 | V-0 | V-0 | V-0 | n.c. | n.c. | n.c. | V-2 |
| UL 94 (3.2 mm), 7 days, 70° C. | V-0 | V-0 | V-0 | V-0 | V-1 | n.c. | n.c. | n.c. | V-2 |
| UL 94 (3.2 mm), classification | V-0 | V-0 | V-0 | V-0 | V-1 | n.c. | n.c. | n.c. | V-2 |
| GWFI (1.6 mm) [° C.] | 960 | 900 | 900 | 960 | 900 | <750 | 750 | 800 | 850 |

n.c.: no classification in accordance with IEC 60695-11-10,
sc: standard climatic conditions,
^{a)}the average value (arithmetic average) is stated.

### Standards for Determination of Mechanical Data

The mechanical data stated in Table 2 were determined in accordance with the following standards.

Tensile Strain at Break:

ISO 527 with tensile testing speed 5 mm/min

ISO tensile specimen, standard: ISO 3167, type A, 170×20/10×4 mm, temperature 23° C.

### Charpy Impact Resistance:

ISO 179-2/leU (Charpy impact resistance)

ISO impact specimen, standard: ISO 179-1, type 1, 80×10×4 mm, temperature 23° C.

### Standard for Determination of Shrinkage During Processing:

ISO 294-4, ISO plaques type D2 in accordance with ISO 294-3, 60×60×2 mm.

Specification for Determination of Glass Fibre Length Distribution

1.5 g of the specimen were added to 25 ml of a mixture of trifluoroethanol and chloroform (3 parts by volume of trifluoroethanol, 2 parts by volume of chloroform), allowed to stand for 14 hours at 22° C., and then treated with ultrasound for 30 minutes. The soluble constituents were removed together with the solvent by filtration through a G2 glass frit. The dry residues in the glass frit were transferred to a microscope slide. Glass fibre length distribution was determined at 125-times magnification in accordance with Section 6.2 to 6.4 of ISO 22314:2006(E). The measurement was made on 3 images with in each case 200 fibres.

### Specification for Determination of Flame-Retardant Properties

Flame-retardant properties were determined in the vertical fire test in accordance with IEC 60695-11-10 (UL 94), on test specimens with the wall thicknesses stated in Table 2. Before the test, the test specimens were stored in standard climatic conditions (23° C., 50% relative humidity) for 48 hours and, respectively, at 70° C. for 7 days.

### Specification for Determination of GWFI (Glow Wire Flammability Index)

Glow wire resistance was determined by testing with the glow wire for the flammability of materials in accordance with IEC 60695-2-12 on square plaques with 100 mm side length and with the wall thicknesses stated in Table 2. Before the test, the test specimens were stored in standard climatic conditions (23° C., 50% relative humidity) for 48 hours.

Comparison of the Inventive Examples IE1 to IE3 with the Comparative Examples CE1 to CE3 reveals impressively that markedly better flame-retardant properties are obtained by using the glass fibres of the invention with average length from 100 to 220 μm than by using conventional glass fibres. Whereas the Comparative Examples do not achieve any fire protection class at all in accordance with IEC 60695-11-10 (UL 94), the glass fibres of the invention achieve this even when only 7 percent by weight of the flame retardant is used.

Comparison of Inventive Example IE2 with Comparative Example CE4 reveals that use of the glass fibres of the invention with a melamine-cyanurate-based flame retardant leads to values that are clearly substantially poorer than those obtained with the flame retardants (C) of the invention. There is therefore a correlation between the selected flame retardant and the selected fibres.

Surprisingly, -polyamide moulding compositions with excellent flame-retardaht properties are provided only by the feature combination found by the inventors: (B) glass fibres of average length from 100 to 220 μm and (C) a phosphinic and/or diphosphinic salt.

1. A polyamide moulding composition consisting of the following components:
(A) from 25 to 90% by weight of at least one polyamide,
(B) from 5 to 60% by weight of glass fibres, where the arithmetic average of the length of these glass fibres in the polyamide moulding composition is from 100 to 220 m,
(C) from 5 to 25% by weight of at least one phosphinic salt and/or at least one diphosphinic salt, and
(D) from 0 to 20% by weight of at least one additive,
where the entirety of components (A) to (D) gives 100% by weight.

2. The polyamide moulding composition according to claim 1, wherein component (A) involves at least one, or a mixture, of the systems selected from the group consisting of: PA 6; PA 46; PA 66; PA 66/6; PA 610; PA 612; PA 1010; PA 11; PA 12; PA MXD6; PA MXD10; PA MACM 12; PA PACM 12; PA 6T/6I; PA 6T/66; PA 6T/612; PA 6T/1012; PA 4T; PA 9T; PA 10T; PA 12T; PA 10/6T; PA 6T/61/66; PA 11/10T; PA 12/10T; PA 610/10T; PA 612/10T; PA 1010/10T; PA 1012/10T; PA 1212/10T; PA 11/10T/12; PA 11/10T/6; PA 12/10T/6; PA 11/10T/10I; PA 11/10T/106; PA 12/10T/10I; PA 12/10T/106; polyamides based on a mixture of hexamethylenediamine and 2-methylpentamethylenediamine as diamine component and terephthalic acid as diacid component; polyamides of which the diamine unit is 4,4′-diaminocyclohexylmethane, 3,3′-dimethyl-4,4′-diaminocyclohexylmethane, cyclohexyldiamine or 2,2′,6,6′-tetramethyl-4,4′-methylenebis(cyclohexylamine.

3. The polyamide moulding composition according to any claim 1, wherein the moulding composition is classified as V-0 in accordance with IEC 60695-11-10 (UL 94) for a test specimen wall thickness of 1.6 mm, for a test specimen wall thickness of 3.2 mm, or both for a test specimen wall thickness of 1.6 mm and 3.2 mm.

4. The polyamide moulding composition according to claim 1, wherein the at least one additive is selected from the group consisting of: glass beads, mineral powders, UV stabilizers, heat stabilizers, lubricants and mould-release aids, impact modifiers, dyes and markers, inorganic pigments, organic pigments, IR absorbers, antistatic agents, antiblocking agents, nucleating agents, crystallization accelerators, crystallization retarders, chain-extending additives, conductivity additives, optical brighteners, photochromic additives, crosslinking agents, intumescence agents, foreign polymers and/or mixtures thereof.

5. The polyamide moulding composition according to claim 1, wherein the tensile strain at break, determined in accordance with ISO 527, is more than 3.5%.

6. The polyamide moulding composition according to claim 1, wherein the proportion of glass fibres (B) is from 5 to 55% by weight, based on the total composition of components (A) to (D).

7. The polyamide moulding composition according to claim 1, wherein the proportion of the at least one phosphinic salt and/or diphosphinic salt of component (C) in the entire polyamide moulding composition is from 5 to 22% by weight.

8. The polyamide moulding composition according to claim 1, wherein the proportion of the at least one additive is from 0.001 to 18% by weight.

9. The polyamide moulding composition according to claim 1, wherein the cross section of the glass fibres is circular.

10. The polyamide moulding composition according to claim 1, wherein the GWFI of the moulding compositions, determined in accordance with IEC 60695-2-12, is at least 850° C.

11. The polyamide moulding composition according to claim 1, wherein
component (A) is composed exclusively of
(A1) from 5 to 40% by weight of PA 6,
(A2) from 35 to 55% by weight of PA 66, and wherein the entirety of components (A) to (D) gives 100% by weight
where the entirety of components (A) to (D) gives 100% by weight.

12. A process for the production of a polyamide moulding composition according to claim 1, wherein when the polyamide (A) is charged to an extruder it comprises glass fibres of a length which is greater than the length in the resultant polyamide moulding composition.

13. A moulding which is composed at least in regions of a polyamide moulding composition according to claim 1.

14. The moulding according to claim 13, wherein its wall thickness is more than 1 mm.

15. A method of using glass fibres with an arithmetic average length of from 100 to 220 μm in combination with at least one phosphinic salt and/or one diphosphinic salt for the production of flame-retardant polyamide moulding compositions and/or mouldings, or method of using glass fibres with an arithmetic average length of more than 220 μm in combination with at least one phosphinic salt and/or one diphosphinic salt for the production of flame-retardant polyamide moulding compositions and/or mouldings, where the production process for the polyamide moulding composition/the moulding is adjusted in such a way that the arithmetic average length of the glass fibres in the resultant polyamide moulding composition/moulding is in the range from 100 to 220 μm.

16. The polyamide moulding composition according to claim 1, wherein component (A) involves at least one, or a mixture, of the systems selected from group consisting of: PA 6, PA 66 and mixtures thereof.

17. The polyamide moulding composition according to claim 1, wherein the tensile strain at break, determined in accordance with ISO 527, is more than 4.0%.

18. The polyamide moulding composition according to claim 1, wherein the tensile strain at break, determined in accordance with ISO 527, is more than 5.0%.

19. The polyamide moulding composition according to claim 1, wherein the proportion of glass fibres (B) is from 10 to 50% by weight based on the total composition based on the total composition of components (A) to (D).

20. The polyamide moulding composition according to claim 1, wherein the proportion of glass fibres (B) is from 15 to 40% by weight, based on the total composition based on the total composition of components (A) to (D).

21. The polyamide moulding composition according to claim 1, wherein the proportion of the at least one phosphinic salt and/or diphosphinic salt of component (C) in the entire polyamide moulding composition is from 6 to 23% by weight.

22. The polyamide moulding composition according to claim 1, wherein the proportion of the at least one phosphinic salt and/or diphosphinic salt of component (C) in the entire polyamide moulding composition is from 7 to 21% by weight.

23. The polyamide moulding composition according to claim 1, wherein the proportion of the at least one additive is from 0.01 to 10% by weight.

24. The polyamide moulding composition according to claim 1, wherein the proportion of the at least one additive is from 0.1 to 5% by weight.

25. The polyamide moulding composition according to claim 1, wherein the GWFI of the moulding compositions, determined in accordance with IEC 60695-2-12, is at least 900° C.

26. The polyamide moulding composition according to claim 1, wherein the GWFI of the moulding compositions, determined in accordance with IEC 60695-2-12, is at least 960° C.

27. The polyamide moulding composition according to claim 1, wherein component (A) is composed exclusively of
(A1) from 5 to 15% by weight, of PA 6,
(A2) from 35 to 55% by weight of PA 66,
based in each case on the total composition of components (A) to (D), and wherein the entirety of components (A) to (D) gives 100% by weight.

28. The polyamide moulding composition according to claim 1, wherein the proportion of component (B) present in the polyamide moulding composition is in the range from 15 to 40% by weight, and wherein the arithmetic average length of the glass fibres (B) is in the range from 135 to 200 μm, and wherein the entirety of components (A) to (D) gives 100% by weight.

29. The polyamide moulding composition according to claim 1, wherein the proportion of component (B) present in the polyamide moulding composition is in the range from 25 to 35% by weight, and wherein the arithmetic average length of the glass fibres (B) is in the range from 150 to 200 m, and wherein the entirety of components (A) to (D) gives 100% by weight.

30. The polyamide moulding composition according to claim 1, wherein the proportion of component (C) present is in the range from 5 to 25% by weight, and wherein the entirety of components (A) to (D) gives 100% by weight.

31. The polyamide moulding composition according to claim 1, wherein the proportion of component (D) present in the polyamide moulding composition is in the range from 0.01 to 5% by weight, and wherein the entirety of components (A) to (D) gives 100% by weight.

32. A process for the production of a polyamide moulding composition according to claim 1, wherein when the polyamide (A) is charged to an extruder it already comprises admixtures of components (C) and/or (D), and glass fibres of a length which is greater than the length in the resultant polyamide moulding composition, are added.

33. A process for the production of a polyamide moulding composition according to claim 1, wherein when the polyamide (A) is charged to an extruder glass fibres of a length which is greater than the length in the resultant polyamide moulding composition, where the arithmetic average of the said length is greater than 220 μm or 250 μm, are added, this being achieved in that within the extruder the glass fibres come into contact with at least one kneading and at least one retarding element of the extruder screw.

34. A moulding which is composed at least in regions of a polyamide moulding composition according to claim 1, in the form of a component for the electrical/electronics sector.

35. A moulding which is composed at least in regions of a polyamide moulding composition according to claim 1, in the form of a component for the electrical/electronics sector, namely for parts of circuit boards, of housings, of foils, of lines, of switches, of distributors, of relays, of resistances, of capacitors, of coils, of lamps, of diodes, of LEDs, of transistors, of connectors, of controllers, of storage devices and of sensors, in the form of large-surface-area components, of housing parts for switchgear cabinets and in the form of components of complicated design with sophisticated geometry.

36. The moulding according to claim 13, wherein its wall thickness is more than more than 3 mm.

37. The moulding according to claim 13, wherein its wall thickness is more than 1 mm and where the wall thickness does not exceed 10 mm.

38. A method of using glass fibres with an arithmetic average length of from 100 to 220 μm in combination with at least one phosphinic salt and/or one diphosphinic salt for the production of flame-retardant polyamide moulding compositions and/or mouldings, or method of using glass fibres with an arithmetic average length of more than 220 μm in combination with at least one phosphinic salt and/or one diphosphinic salt for the production of flame-retardant polyamide moulding compositions and/or mouldings, where the production process for the polyamide moulding composition/the moulding is adjusted in such a way that the arithmetic average length of the glass fibres in the resultant polyamide moulding composition/moulding is in the range from 100 to 220 μm, where the polyamide moulding composition/the moulding are classified as V-0 in accordance with IEC 60695-11-10 (UL 94).
